(19) United States
(12) Patent Application Publication
(10) Pub. No.: US 2011/0042287 A1
(43) Pub. Date: Feb. 24, 2011

(54) Portable Water Softener

(76) Inventor: John Staines, Hamilton (CA)

Correspondence Address: ELIAS BORGES, 56 Aberfoyle Crescent, Suite 840, Canada, ON, M8X2W4, CA

(21) Appl. No.: 12/545,262

(22) Filed: Aug. 21, 2009

(51) Int. Cl. C02F 5/00; B01D 24/14; C02F 1/42

(52) U.S. Cl. 210/188; 210/264

(57) ABSTRACT

A portable water softener for converting hard water from a household water outlet to softened water is disclosed. The portable water softener includes an elongated housing having opposite first and second ends and an elongated conduit having opposite first and second ends. The first end of the conduit is coupled to the first end of the housing by a first water connector element while the second end of the conduit is coupled to the second end of the housing by a second water connector element. The conduit extends between the first and second ends of the housing in a sinusoidal fashion and contains a quantity of water softening ion exchange beads. The portable water softener also includes a first flush port coupled to the first end of the housing and the first end of the conduit and a second flush port coupled to the second end of the housing and the second end of the conduit. The portable water softener also includes a mount for mounting the housing in a vertical orientation with the first end of the housing above the second end of the housing, the mount being further configured to permit the housing to be mounted in a reverse vertical orientation with the second end of the housing above the first end of the housing.

### FIELD OF THE INVENTION

The invention relates generally to water softeners.

### BACKGROUND OF THE INVENTION

Tap water often contains naturally occurring calcium ions. Water which has a relatively high concentration of calcium is popularly referred to as hard water while water which has relatively few calcium ions is referred to as soft water. Hard water has several disadvantages compared to soft water. Firstly, hard water has a tendency to form stains and buildup on faucets, drains, bathtubs, shower stalls, sinks and the like. Also, hard water has a tendency to decrease the effectiveness of soaps and detergents. Additionally, hard water leaves a residue or film after it dries. This film or residue can cause skin irritation and roughness. In order to remove calcium from hard water, water softeners are often employed. These softeners usually include a quantity of ion exchange resin beads which are loaded with sodium ions. The hard water is passed over the resin beads and the calcium in solution is exchanged for the sodium on the beads, leaving the water with less calcium but increased sodium. Traditionally, these water softeners have consisted of large devices having a large tank filled with ion exchange resin beads, a tank of salt for periodically recharging the resin beads, plumbing fixtures for attaching the device to the water inlet and water outlet and a complicated arrangement of pumps, valves and timers for periodically recharging the resin beads by flowing a quantity of brine solution through the beads. An inexpensive and portable water softener unit which is easy to install and operate would have many applications which are not adequately addressed by currently available water softening units.

### SUMMARY OF THE INVENTION

In accordance with one aspect of the present invention, there is provided a portable water softener for converting hard water from a household water outlet to softened water. The portable water softener includes an elongated housing having opposite first and second ends and an elongated conduit having opposite first and second ends. The first end of the conduit is coupled to the first end of the housing by a first water connector element while the second end of the conduit is coupled to the second end of the housing by a second water connector element. The conduit extends between the first and second ends of the housing in a sinusoidal fashion and contains a quantity of water softening ion exchange beads. The portable water softener also includes a first flush port coupled to the first end of the housing and the first end of the conduit and a second flush port coupled to the second end of the housing and the second end of the conduit. The portable water softener also includes a mount for mounting the housing in a vertical orientation with the first end of the housing above the second end of the housing, the mount being further configured to permit the housing to be mounted in a reverse vertical orientation with the second end of the housing above the first end of the housing.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a side view of a portable water softener made in accordance with the present invention hanging on a shower head.

FIG. 2 is a sectional view of the portable water softener shown in figure one taken along line A-A.

In the drawings like characters of reference indicate corresponding parts in the different figures.

### DETAILED DESCRIPTION OF THE INVENTION

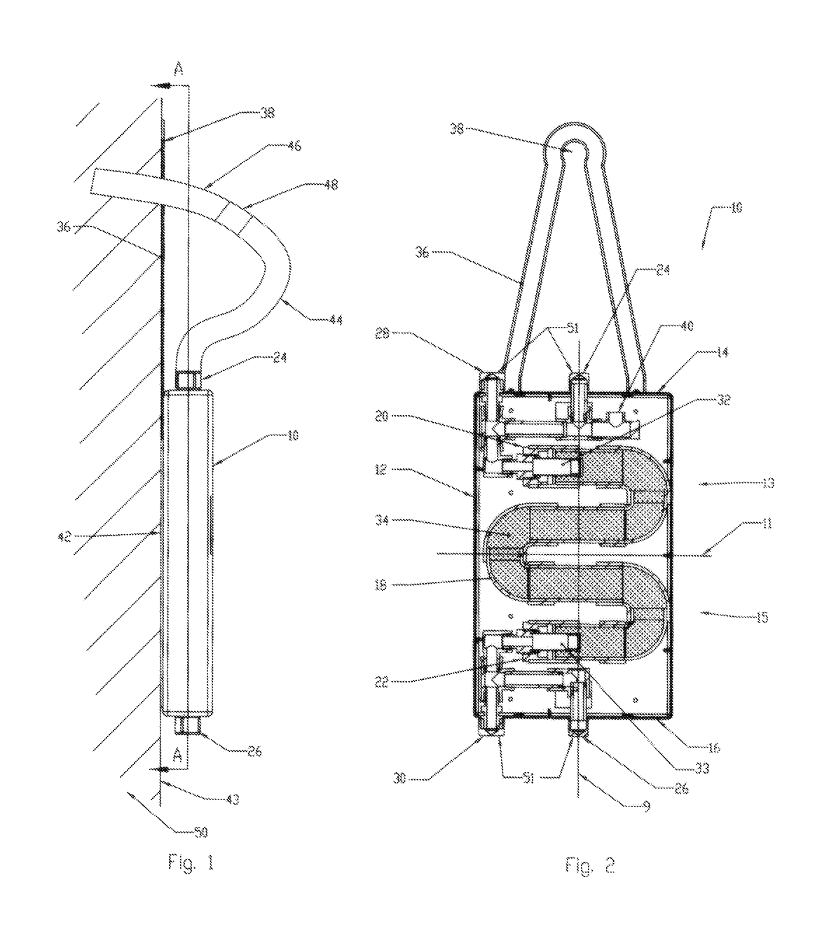

Referring to FIGS. 1 and 2, a portable water softener made in accordance with the present invention in shown generally as item 10 and consists of a housing 12 having opposite ends 14 and 16. Conduit 18 is contained within housing 12 and has opposite ends 20 and 22 coupled to ends 14 and 16 by water connector elements 24 and 26, respectively. Conduit 18 is sinusoidal in shape, meaning that it is curved into a series of back and forth bends which have the effect of permitting a relatively long conduit to fit within housing 12. First and second filters 32 and 33 are provided adjacent ends 20 and 22 of conduit 18 in order to contain a quantity of ion exchange resin beads 34 within conduit 18. Flush ports 28 and 30 are coupled to ends 20 and 22 of conduit 18 and to water connector elements 24 and 26, respectively. Water connector elements 24 and 26 and flush ports 28 and 30 preferably consist of standard sized screw type household hose plumbing fittings of the type used for garden houses and the like.

Mount 36 is provided which is releasably mountable to housing 12 and permits portable water softener 12 to be mounted vertically with either housing end 14 or 16 at the top. Portable water softener 10 has a vertical axis 9 and a horizontal axis 11. Connector elements 24 and 26 are preferably coaxially aligned with vertical axis 9 and housing 12 is preferably vertically symmetrical about horizontal axis 11 so that the water softener can be inverted and mounted with either housing end 14 or 16 oriented upwards. This permits the unit to be periodically inverted, as shall be discussed in greater detail further on. A pressure relief valve 40 is coupled to conduit 18 and is configured to vent if the pressure within conduit 18 exceeds a predetermined limit. Caps 51 are provided to close off connector elements 24 and 26 and flush ports 28 and 30 when not in use.

As shown in FIG. 1, water softener 10 has a substantially flat back face 42 which is sufficiently flat to permit the housing to lie flat against surface 43 of wall 50. Mount 36 has portion 38 which is dimensioned and configured to hang from shower head 46 so that the portable water softener 10 can be mounted from a shower head in a shower stall. Flexible water house 44 may then be coupled to shower head 46 by coupling 48 at one end and to water connector 24 at the other end. A portable hand operated shower wand (not shown) can then be coupled to water connector 26. This permits the user to shower using the portable water softener to soften the water before it discharges water connector element 26. After a period of several uses, the user can then simply disconnect the shower head and shower wand (not shown) from the portable water softener, invert mount 36 and hang the portable water softener with water connector element 26 oriented upward. This extends the life of the resin beads between regeneration. To regenerate the water softening beads, cap 51 is removed from flush port 28 (assuming the water softener is mounted with water connector element 24 oriented upwards) and a quantity of brine is poured in through flush port 28. The water softener is left to stand with the brine for a period of time before cap 51 from flush port 30 is removed to let the brine drain. Caps 51 are replaced on the flush ports and a quantity of water is passed through the unit to permit the remaining brine to be washed away.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A portable water softener for converting hard water from a household water outlet to softened water, comprising:
an elongated housing having opposite first and second ends;
a conduit having opposite first and second ends, the first end of the conduit being coupled to the first end of the housing by a first water connector element, the second end of the conduit being coupled to the second end of the housing by a second water connector element, the conduit extending between the first and second ends of the housing in a convoluted fashion;
the conduit containing a quantity of water softening ion exchange beads;
a first flush port coupled to the first end of the housing and the first end of the conduit;
a second flush port coupled to the second end of the housing and the second end of the conduit;
a mount for mounting the housing in a vertical orientation with the first end of the housing above the second end of the housing, the mount being further configured to permit the housing to be mounted in a reverse vertical orientation with the second end of the housing above the first end of the housing.

2. The portable water softener of claim 1 wherein the first and second water connector elements comprise standard sized screw type water fittings.

3. The portable water softener of claim 1 further comprising a pressure relief valve coupled to the conduit.

4. The portable water softener of claim 1 further comprising first and second filters adjacent the first and second ends of the conduit, respectively, for retaining the water softening resin beads between the first and second filters.

5. The portable water softener of claim 1 wherein the mount is configured to hang the housing from a shower head.

6. The portable water softener of claim 5 wherein the first and second water connector elements comprise standard sized screw type water fittings.

7. The portable water softener of claim 1 wherein the first and second water connector elements are identical.

8. The portable water softener of claim 1 wherein the housing is vertically symmetrical and wherein the first and second water connector elements comprise identical standard sized screw type water fittings.

9. The portable water softener of claim 1 wherein the housing has a substantially flat back face.
